(19) United States
(12) Patent Application Publication
(10) Pub. No.: US 2025/0177903 A1
(43) Pub. Date: Jun. 5, 2025

(54) GAS PURIFICATION DEVICE

(71) Applicant: TAIYO NIPPON SANSO CORPORATION, Tokyo (JP)

(72) Inventors: Satoru Misawa, Tokyo (JP); Hiroyuki Takei, Tokyo (JP); Tatsuo Soejima, Tokyo (JP)

(73) Assignee: TAIYO NIPPON SANSO CORPORATION, Tokyo (JP)

(21) Appl. No.: 18/844,074

(22) PCT Filed: Mar. 10, 2023
(86) PCT No.: PCT/JP2023/009238

§ 371 Date: Sep. 5, 2024

(30) Foreign Application Priority Data
Mar. 11, 2022 (JP) 2022-037825

(51) Int. Cl. B01D 53/053; B01D 53/04

(52) U.S. Cl. CPC B01D 53/053; B01D 53/0423; B01D 53/0446; B01D 2256/18; B01D 2257/102; B01D 2257/104

(57) ABSTRACT

A gas purification device capable of maximizing recovery benefits by reducing an amount of loss of a purified gas while suppressing an increase in price of the device and an increase in size of the device, the gas purification device comprising: a compressor configured to compress a raw material gas; and an adsorption tower filled with an adsorbent into which the compressed raw material gas is introduced, the adsorption tower being configured to purify the raw material gas by a pressure swing adsorption method including sequentially performing an adsorbing step and a regenerating step to conduct gas separation, wherein a residual gas recovery path connecting an outlet side of the adsorption tower and a suction side of the compressor is provided, and the residual gas recovery path includes a pressure regulator such as a pressure reducing valve. A mass flow controller is provided on a raw material supply path.

### TECHNICAL FIELD

The present invention relates to a gas purification device, and more specifically relates to a gas purification device that recovers and purifies an expensive noble gas such as helium containing impurities in a high yield by means of pressure swing adsorption (PSA).

### BACKGROUND ART

Helium has properties such as a high thermal conductivity, a high diffusibility, and a low boiling point and is used in a wide variety of industrial fields such as MRI, optical fibers, semiconductors, and leak tests. While the growth of demand for helium has been expected worldwide, regarding the supply of helium, there is always a concern about the risk of shortage of supply amount due to reduction in amount of production from gas fields containing helium, prolonged troubles in helium production facilities, and the like. Among demanders who are worried about the risk on the supply side, there are movements of taking countermeasures such as the saving of helium and recycling, and an increase in need for the recovery of helium has been predicted.

Recovered helium often contains the air (nitrogen, oxygen, carbon dioxide, water, and the like) as impurities. One of the purification methods for removing impurities from recovered helium is a pressure swing adsorption method (PSA method). A gas purification device according to a general PSA method has a basic configuration including two adsorption towers and eight valves, and repeats an adsorbing step, a pressure equalizing and reducing step, a regenerating step, and a pressure equalizing and increasing step to continuously purify a gas. In the regenerating step, since the gas in the adsorption towers was exhausted to conduct a pressure reducing operation, a loss of helium occurs. To reduce the loss of helium at the time of the regenerating step, a pressure equalizing operation is conducted. In a PSA device of two-tower system, a residual gas in the adsorption tower in which the adsorbing step was completed is recovered to the adsorption tower in which the regenerating step was completed in the pressure equalizing step. Here, it is possible to further reduce the loss of helium by providing three or more adsorption towers and setting the number of pressure equalizing operations to two or more. However, an increase in the number of adsorption towers is limited because it causes problems such as an increase in price of the device and an increase in size of the device.

In view of this, a device and a method that mix and recycle an exhaust gas of a PSA device with a raw material gas to recover a noble gas have been proposed in order to reduce a loss of helium (Patent Literature 1).

### CITATION LIST

### Patent Literature

Patent Literature 1: Japanese Patent No. 3385053

### SUMMARY OF INVENTION

### Technical Problem

However, in the device and method of Patent Literature 1, when an exhaust gas is mixed with a raw material gas, the concentration of removed components in the raw material gas increases, and therefore, in order to supply a product gas with a certain purity, it is necessary to always measure the concentration of impurities in the raw material gas or the product gas by using an analyzer to adjust the gas treatment amount in the PSA in accordance with the concentration. In order to optimize the value of flow rate for the measured value of the concentration of impurities using an analyzer, adjustment of control parameters is required, so that high developments and increased complications of the control system have been problems.

In view of this, an object of the present invention is to provide a gas purification device that does not need construction of a complicated control system based on measurement of a concentration by using an analyzer and can reduce an amount of loss of a purified gas (helium) and maximize recovery benefits while suppressing an increase in price of the device and an increase in size of the device.

### Solution to Problem

To achieve the above-described object, a gas purification device of the present invention is a gas purification device comprising: a compressor configured to compress a raw material gas; and an adsorption tower filled with an adsorbent into which the compressed raw material gas is introduced, the adsorption tower being configured to purify the raw material gas by a pressure swing adsorption method including sequentially performing an adsorbing step and a regenerating step to conduct gas separation, wherein a residual gas recovery path connecting an outlet side of the adsorption tower and a suction side of the compressor is provided, the residual gas recovery path includes a pressure regulator, a mass flow controller is provided on a raw material supply path on an exhaust side of the compressor, a bypass path bypassing the mass flow controller is provide, and the bypass path includes a valve.

In addition, the gas purification device of the present invention comprises a plurality of the adsorption towers, wherein the raw material gas is a noble gas containing air, oxygen, or nitrogen as an impurity. In addition, a buffer tank may be provided between the compressor and the mass flow controller. Moreover, a vacuum pump is provided on an inlet side of the raw material gas, and a pressure of the adsorption tower is reduced in the regenerating step.

### Advantageous Effects of Invention

According to the gas purification device of the present invention, it is possible to recover a residual gas in the adsorption tower in which the adsorbing step was completed in a pressure equalizing and reducing step and further to reduce an amount of loss of the purified gas by causing the residual gas to join the raw material gas on the suction side of the compressor. In addition, by providing the pressure regulator such as a pressure reducing valve in the residual gas recovery path, it is possible to maintain the suction pressure of the compressor at the atmospheric pressure irrespective of the pressure of the adsorption tower.

Moreover, by providing the mass flow controller, it is possible to automatically maintain the purity of the product gas even if the concentration of impurities in the raw material gas increases. In addition, by providing the bypass path bypassing the mass flow controller and including the valve in the bypass path, it is possible to handle a temporary increase in flow rate of the raw material gas at the time of recovering the residual gas by increasing the introduction flow rate into an adsorption tower.

### BRIEF DESCRIPTION OF DRAWINGS

FIG. 1 is a system diagram showing one embodiment of a gas purification device of the present invention capable of implementing a gas purification method of the present invention.

FIG. 2 is a diagram showing a timing chart showing a temporal order of steps in adsorption towers and opened and closed states of the respective valves in the present invention.

### DESCRIPTION OF EMBODIMENTS

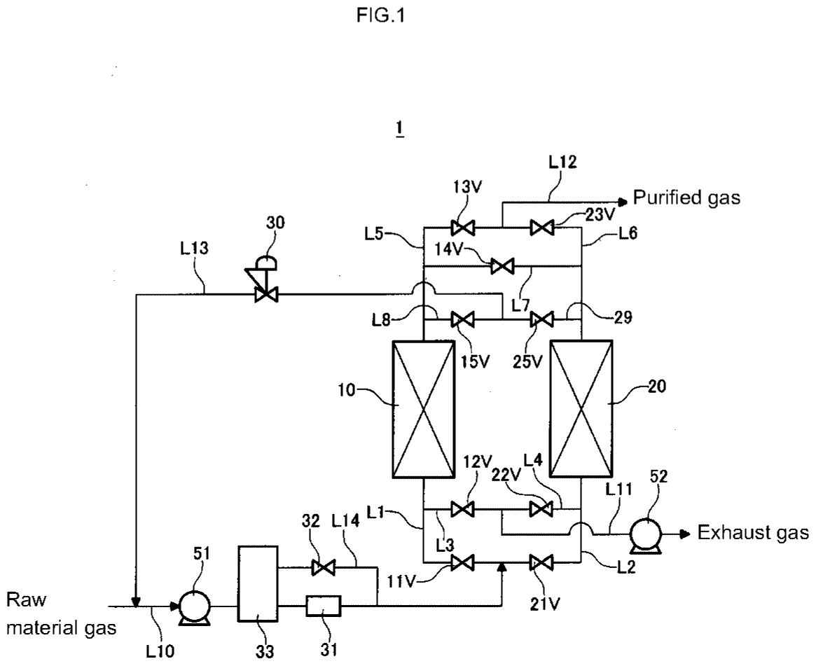

FIG. 1 is a system diagram showing one embodiment of a gas purification device of the present invention capable of implementing a gas purification method of the present invention. A gas purification device 1 shown in the present embodiment is a pressure swing adsorption-type gas separation device (PSA device) with two towers, using two adsorption towers (a first adsorption tower 10 and a second adsorption tower 20) filled with an adsorbent, and is formed to be capable of separating an impurity component gas from a raw material gas containing the impurity component gas and continuously guiding a purified gas containing a main component gas with high purity by alternately switching an adsorbing step and a regenerating step in each of the adsorption towers. In addition, when the adsorbing step and the regenerating step are switched, a pressure equalizing operation of moving the in-tower gas from one of the adsorption tower to the other adsorption tower is conducted.

The raw material gas in the present embodiment is helium containing the air as an impurity component gas.

On the raw material gas inlet sides of the respective adsorption towers 10 and 20 (the lower portions of the towers), raw material gas inlet paths L1 and L2 having inlet valves 11V and 21V and pressure reducing exhaust paths L3 and L4 having pressure reducing exhaust valves 12V and 22V are provided.

On the purified gas outlet sides of the respective adsorption towers 10 and 20 (the upper portions of the towers), purified gas outlet paths L5 and L6 having outlet valves 13V and 23V are provided. In addition, in a pressure equalizing path L7 connecting the purified gas outlet sides of the respective adsorption towers 10 and 20, a pressure equalizing valve 14V is provided. Moreover, on the purified gas outlet sides of the respective adsorption towers 10 and 20, residual gas guiding paths L8 and L9 having residual gas guiding valves 15V and 25V for guiding a gas remaining in the adsorption towers are provided.

Moreover, the raw material gas inlet paths L1 and L2 are connected to a raw material supply path L10 having a compressor 51, and the pressure reducing exhaust paths L3 and L4 are connected to a vacuum exhaust path L11 having a vacuum pump 52. On the other hand, the purified gas outlet paths L5 and L6 are connected to a purified gas guiding path L12.

In addition, the residual gas guiding paths L8 and L9 are connected to a residual gas recovery path L13 which joins the raw material supply path L10 on the suction side of the compressor 51. The residual gas recovery path L13 includes a pressure reducing valve 30.

In the raw material supply path L10 on the exhaust side of the compressor 51, a mass flow controller (MFC) 31 is provided, a bypass path L14 bypassing the mass flow controller 31 is provided, and the bypass path L14 includes a valve 32. The valve 32 is an automatic valve. As the MFC 31, a mass flow controller for a noble gas is preferably used.

Moreover, between the compressor 51 and the mass flow controller 31, a buffer tank 33 for reducing pulsation caused by the compressor 51 is provided.

In addition, inside the adsorption towers 10 and 20, two types of adsorbents, a first adsorbent and a second adsorbent, for adsorbing impurities in the raw material gas are stacked and loaded. As the adsorbents, zeolite, activated alumina, silica gel, or the like can be used.

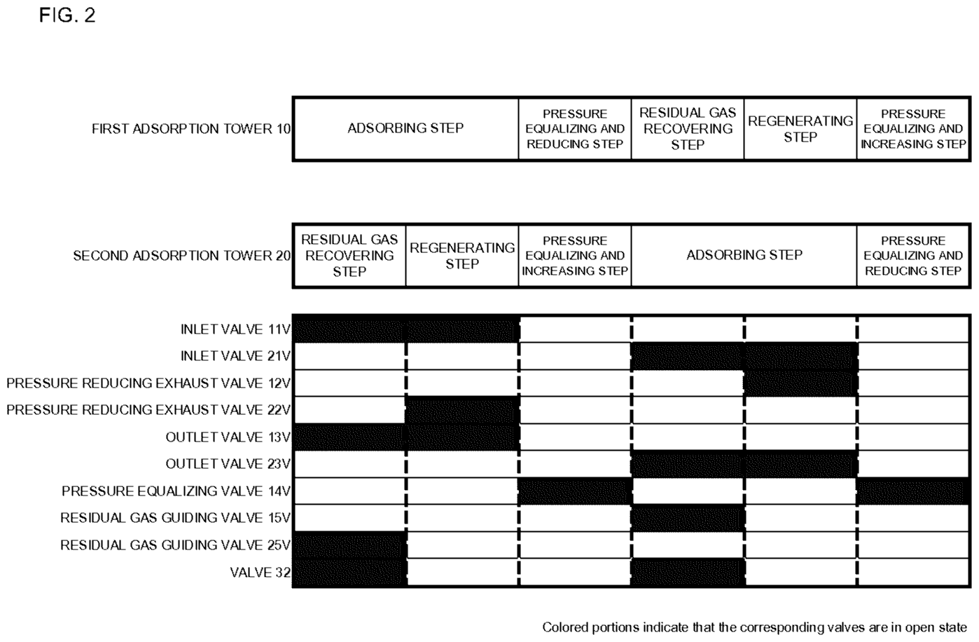

The gas purification and separation method of the present invention executes an adsorbing step, a pressure equalizing and reducing step, a residual gas recovering step, a regenerating step, and a pressure equalizing and increasing step alternately in the adsorption towers 10 and 20 with time, and is conducted in accordance with a sequence as shown in FIG. 2. FIG. 2 shows opened and closed states of the respective valves in association with each step, and colored portions indicate that the corresponding valves are in open state.

Helium (raw material gas) compressed (pressurized) by the compressor 51 enters the first adsorption tower 10 from the raw material supply path L10 and the raw material supply path L1 via the MFC 31 and the inlet valve 11V. In the first adsorption tower 10, the air, which is an impurity in helium, is adsorbed by the adsorbent, and helium passes through the purified gas outlet path L5 and the purified gas guiding path L12 via the outlet valve 13V and is taken out as a purified gas (product gas). Such a step is the adsorbing step in the first adsorption tower 10. The adsorbing step continues for, for example, 1 to 24 hours and preferably 4 to 24 hours.

When the first adsorption tower 10 is in the adsorbing step, the residual gas recovering step and the regenerating step are conducted in the second adsorption tower 20.

In the residual gas recovering step, the gas retained (remaining) in the second adsorption tower 20 is caused to pass through the residual gas guiding path L9 and the residual gas recovery path L13 via the residual gas guiding valve 25V and the pressure reducing valve 30 and join the raw material supply path L10 on the suction side of the compressor 51. By providing the pressure reducing valve 30, it is possible to maintain the suction pressure of the compressor 51 at the atmospheric pressure irrespective of the pressures of the adsorption towers. The residual gas recovering step is conducted for, for example, 1 hour or less, and preferably 30 minutes or less.

When the second adsorption tower 20 is in the residual gas recovering step, the flow rate of the raw material gas temporarily increases for the gas recovered from the second adsorption tower 20 in the adsorbing step of the first adsorption tower 10. For this reason, the introduction flow rate into the first adsorption tower 10 is increased through the bypass path L14 via the valve 32.

Subsequently, the valve 32 and the residual gas guiding valve 25V are closed to end the residual gas recovering step of the second adsorption tower 20, and the regenerating step is conducted. In the regenerating step, the gas inside the second adsorption tower 20 is sucked by the vacuum pump 52 through the pressure reducing exhaust path L4 and the vacuum exhaust path L11 via the pressure reducing exhaust valve 22V. This reduces the pressure in the second adsorption tower 20 to cause the air, which is the adsorbed impurity, to be desorbed to regenerate the adsorbent. The regenerating step is continued for, for example, 1 to 24 hours and preferably 4 to 24 hours.

Before the first adsorption tower 10 reaches adsorption saturation, the inlet valve 11V and the outlet valve 13V are closed to end the adsorbing step of the first adsorption tower 10, and also the pressure reducing exhaust valve 22V is closed to end the regenerating step of the second adsorption tower 20. Subsequently, the pressure equalizing valve 14V is opened to allow the outlet sides of the first adsorption tower 10 and the second adsorption tower 20 to communicate with each other through the pressure equalizing path L7 to conduct a pressure equalizing operation, so that the gas inside the first adsorption tower 10 is introduced into the second adsorption tower 20. This step serves as the pressure equalizing and reducing step in the first adsorption tower 10 and also serves as the pressure equalizing and increasing step in the second adsorption tower 20. The pressure equalizing and reducing step and the pressure equalizing and increasing step are conducted for, for example, 5 minutes or less, and preferably about 1 to 3 minutes.

The second adsorption tower 20 in which the pressure equalizing and increasing step has ended conducts the adsorbing step. As in the case of the above-mentioned adsorbing step of the first adsorption tower 10, helium compressed by the compressor 51 enters the second adsorption tower 20 from the raw material supply path L10 and the raw material supply path L2 via the MFC 31 and the inlet valve 21V, the air, which is the impurity, is adsorbed by the adsorbent in the second adsorption tower 20, and helium passes through the purified gas outlet path L6 and the purified gas guiding path L12 via the outlet valve 23V and is taken out as a purified gas.

When the second adsorption tower 20 is in the adsorbing step, the residual gas recovering step and the regenerating step are conducted in the first adsorption tower 10.

In the residual gas recovering step of the first adsorption tower 10, the gas remaining in the first adsorption tower 10 is caused to pass through the residual gas guiding path L8 and the residual gas recovery path L13 via the residual gas guiding valve 15V and the pressure reducing valve 30 and join the raw material supply path L10 on the suction side of the compressor 51.

At this time, the flow rate of the raw material gas temporarily increases for the gas recovered from the first adsorption tower 10. For this reason, the introduction flow rate into the second adsorption tower 20 is increased through the bypass path 14 via the valve 32.

Subsequently, the valve 32 and the residual gas guiding valve 15V are closed to end the residual gas recovering step of the first adsorption tower 10, and the regenerating step is conducted. In the regenerating step, the gas inside the first adsorption tower 10 is sucked by the vacuum pump 52 through the pressure reducing exhaust path L3 and the vacuum exhaust path L11 via the pressure reducing exhaust valve 12V to reduce the pressure in the first adsorption tower 10 to cause the air, which is the adsorbed impurity, to be desorbed to regenerate the adsorbent.

Before the second adsorption tower 20 reaches adsorption saturation, the inlet valve 21V and the outlet valve 23V are closed to end the adsorbing step of the second adsorption tower 20, and also the pressure reducing exhaust valve 12V is closed to end the regenerating step of the first adsorption tower 10. Subsequently, the pressure equalizing valve 14V is opened to allow the outlet sides of the first adsorption tower 10 and the second adsorption tower 20 to communicate with each other through the pressure equalizing path L7 to conduct a pressure equalizing operation, so that the gas inside the second adsorption tower 20 is introduced into the first adsorption tower 10. This step serves as the pressure equalizing and increasing step in the first adsorption tower 10 and also serves as the pressure equalizing and reducing step in the second adsorption tower 20.

The gas purification device 1 of the present embodiment repeats, in the adsorption towers 10 and 20, the above-mentioned series of conducting the adsorbing step, the pressure equalizing and reducing step, the residual gas recovering step, the regenerating step, and the pressure equalizing and increasing step and returning to the adsorbing step alternately in the adsorption towers 10 and 20 with time, thus being capable of continuously purifying the raw material gas.

Moreover, it is possible to achieve an improvement in recovery benefits without using an auxiliary adsorption tower or a recovery tank by resupplying the residual gas after the pressure equalizing operation to the suction side of the compressor 51 in the residual gas recovering step in addition to recovering the residual gas in the adsorption tower in which the adsorbing step has ended to the other adsorption tower through the pressure equalizing operation.

In addition, when the residual gas inside the adsorption tower is resupplied to the suction side of the compressor 51, since the residual gas is caused to join the raw material gas, the flow rate in the raw material supply path L10 temporarily increases. In addition, the other adsorption tower is in the state immediately after the start of the adsorbing step, and it is necessary to increase the internal pressure of the adsorption tower to a desired adsorption pressure. Since the purified gas cannot be taken out from the adsorption tower in which the pressure is being increased, it is desirable that the pressure increasing step is completed in a short period of time. In the present invention, the bypass path L14 which bypasses the mass flow controller is provided, and by opening the valve 32, which is an automatic valve, in the bypass path L14, it is possible to handle an increase in flow rate and also to shorten the time required to increase the pressure of the adsorption tower.

In addition, by using the MFC 31, it is possible to maintain the flow rate at a constant level against variations of the temperature and the pressure of the gas to be introduced into the gas purification device 1. In particular, by using a MFC for a noble gas, in the case where the concentration of the impurity (the air) in the raw material gas has increased, the flow rate is automatically reduced by the operation of the MFC only, thus making it possible to suppress the load on the adsorption tower at a certain level or lower. By employing such a mode, it is possible to maintain the purity of the product gas against an increase in concentration of the impurity in the raw material gas without constructing a complicated control system based on measurement of the concentration using an analyzer.

Note that by recovering the residual gas from the outlet side of the adsorption tower, it is possible to efficiently recover the gas with a high concentration of helium.

In addition, at the time of recovering the residual gas, it is necessary to maintain the suction side at around the atmospheric pressure in order to prevent an increase of load and failures of the compressor. For this reason, it can be considered to provide a balloon tank of capacity variable type or the like; however, a balloon tank generally has low air tightness, and there is a concern that helium flows to the outside. In this regard, in the present invention, by providing the pressure reducing valve 30 in the residual gas recovery path L13, it is possible to maintain the suction side at the atmospheric pressure.

Note that the present invention is not limited to the above-mentioned embodiment, and the embodiment can be modified in various manners without departing from the gist of the present invention.

Although the above-mentioned embodiment is described with the PSA device with two towers, the number of adsorption towers may be only one or may be three or more. In addition, the adsorption towers may be divided into a strongly adsorbed component adsorption tower and a weakly adsorbed component adsorption tower, and regeneration may be promoted in the regenerating step by heating the strongly adsorbed component adsorption tower with a heater.

In addition, although the pressure reducing valve is provided on the residual gas recovery path L13, this is not limited to a pressure reducing valve, and a pressure regulator such as a control valve or a pressure regulating valve may be provided.

Moreover, a flow rate regulating valve may be added on the residual gas recovery path L13 to reduce the pressure reducing speed at the time of recovering a residual gas. By controlling the pressure reducing speed at the time of recovering a residual gas, it is possible to adjust the concentration of helium in the gas to be recovered.

In addition, a receiver tank for a product gas may be provided on the purified gas guiding path L12. Moreover, a device for removing a trace amount of impurities, a dust filter, or the like may be attached before and after the gas purification device 1.

In addition, the present invention may be implemented by using a mixed gas of a noble gas other than helium and the air, a noble gas and nitrogen, or a noble gas and oxygen as a raw material gas.

To show the usefulness of the present invention, a test for comparing the yield of helium between the case where the residual gas recovering step was conducted and the case where the residual gas recovering step was not conducted was performed under the following conditions.
Composition of raw material gas: helium 75% (volume), air 25% (volume) Flow rate of raw material gas: 1 m³/h (normal)
Number of adsorption towers: 1
Switching time: 12 h
Upper portion of the tower (weakly adsorbed component): filled with zeolite (CaX), 500 A×height 1800 mm
Lower portion of the tower (strongly adsorbed component): filled with zeolite (NaX), 1 inch×height 1000 mm
Vacuum pump: ultimate pressure 10 Pa, exhaust speed 40 L/min
Purity of purified gas: 99% (volume) or more

While the yield in the case where the residual gas recovering step was not conducted was 75%, the yield in the case where the residual gas recovering step was conducted was improved up to 90%.

### REFERENCE SIGNS LIST

1 . . . gas purification device, 10, 20 . . . adsorption tower, 11V, 21V . . . inlet valve, 12V, 22V . . . pressure reducing exhaust valve, 13V, 23V . . . outlet valve, 14V . . . pressure equalizing valve, 15V, 25V . . . residual gas guiding valve, 30 . . . pressure reducing valve, 31 . . . mass flow controller (MFC), 32 . . . valve, 33 . . . buffer tank, 51 . . . compressor, 52 . . . vacuum pump, L1, L2 . . . raw material gas inlet path, L3, L4 . . . pressure reducing exhaust path, L5, L6 . . . purified gas outlet path, L7 . . . pressure equalizing path, L8, L9 . . . residual gas guiding path, L10 . . . raw material supply path, L11 . . . vacuum exhaust path, L12 . . . purified gas guiding path, L13 . . . residual gas recovery path, L14 . . . bypass path

1. A gas purification device comprising:
a compressor configured to compress a raw material gas; and
an adsorption tower filled with an adsorbent into which the compressed raw material gas is introduced, the adsorption tower being configured to purify the raw material gas by a pressure swing adsorption method including sequentially performing an adsorbing step and a regenerating step to conduct gas separation, wherein
a residual gas recovery path connecting an outlet side of the adsorption tower and a suction side of the compressor is provided, and the residual gas recovery path includes a pressure regulator, a mass flow controller is provided on a raw material supply path on an exhaust side of the compressor, a bypass path bypassing the mass flow controller is provided, and the bypass path includes a valve.

2. The gas purification device according to claim 1, comprising a plurality of the adsorption towers, wherein the raw material gas is a noble gas containing air, oxygen, or nitrogen as an impurity.

3. The gas purification device according to claim 1, wherein a buffer tank is provided between the compressor and the mass flow controller.

4. The gas purification device according to claim 1, wherein a vacuum pump is provided on an inlet side of the raw material gas, and a pressure of the adsorption tower is reduced in the regenerating step.

5. The gas purification device according to claim 2, wherein a buffer tank is provided between the compressor and the mass flow controller.

6. The gas purification device according to claim 2, wherein a vacuum pump is provided on an inlet side of the raw material gas, and a pressure of the adsorption tower is reduced in the regenerating step.

7. The gas purification device according to claim 3, wherein a vacuum pump is provided on an inlet side of the raw material gas, and a pressure of the adsorption tower is reduced in the regenerating step.

8. The gas purification device according to claim 5, wherein a vacuum pump is provided on an inlet side of the raw material gas, and a pressure of the adsorption tower is reduced in the regenerating step.
